(19) United States
(12) Patent Application Publication
(10) Pub. No.: US 2017/0373529 A1
(43) Pub. Date: Dec. 28, 2017

(54) BATTERY BACKUP ARRANGEMENT

(71) Applicant: THOMSON LICENSING, Issy les Moulineaux (FR)

(72) Inventor: William V. FITZGERALD, Zionsville, IN (US)

(73) Assignee: THOMSON LICENSING, Issy les Moulineaux (FR)

(21) Appl. No.: 15/526,752

(22) PCT Filed: Nov. 23, 2015
(86) PCT No.: PCT/US2015/062122

§ 371 Date: May 13, 2017

Related U.S. Application Data
(60) Provisional application No. 62/083,489, filed on Nov. 24, 2014.
(60) Provisional application No. 62/153,952, filed on Apr. 28, 2015.

(51) Int. Cl. H02J 9/06

(52) U.S. Cl. CPC H02J 9/061

(57) ABSTRACT

A module includes a rectifier coupled to an input connector for rectifying an input alternating current (AC), mains supply voltage for a power supply regulator. The passive rectifier applies an input filtered direct current (DC) boosted supply voltage to the power supply regulator, when the filtered DC boosted supply voltage is selectively developed at the input connector. A first sensor senses when the filtered DC boosted supply voltage is selectively developed at the input connector. A switch reduces current loading at the input connector, when the filtered DC boosted supply voltage is developed at the input connector, but not when any of the AC mains supply voltage. An add-on power supply module includes a backup battery for developing the filtered DC boosted supply voltage, in substitution for the unfiltered rectified output supply voltage, when the AC mains supply voltage is unavailable.

### FIELD OF THE INVENTION

The invention relates to a battery backup arrangement in a power supply.

### BACKGROUND OF THE INVENTION

Typically, an alternating current (AC) mains supply voltage is coupled via a two or three input terminal connector that is accessible from outside an enclosure containing an electronic device, for example, a gateway set-top box. The AC voltage energizes the gateway set-top box except when power interruption occurs.

Some users require a battery backup operation feature for energizing at least a selected portion of the circuitry when an interruption in the mains supply voltage is detected. Consequently, a selected portion of the typical functions performed by the gateway set-top box continues to be performed after the mains supply voltage interruption occurs.

In order to produce a versatile gateway set-top box and also reduce the cost for those users who do not require the battery backup operation feature, it may be desirable not to include a battery and at least some of its associated circuitry in the enclosure containing the gateway set-top box. Thus, for those users who do not require the battery backup operation feature, a power cord connected to the AC mains supply voltage source applies the AC voltage via the aforementioned input terminal connector. On the other hand, for those users who do require the battery backup operation feature, it may be desirable to provide the battery and its associated circuitry as an add-on, separate unit that is installed outside and separate from the enclosure containing the gateway set-top box.

In a preferred embodiment, the separate add-on unit applies, via a power cord connected to the previously mentioned input connector, an unfiltered rectified AC voltage having a direct current DC component, as long as no power interruption occurs. The unfiltered rectified AC voltage has a waveform of, for example, a full wave rectified sine wave. On the other hand, when power interruption occurs, an output of the battery is coupled to a boost converter for producing a filtered DC voltage at a sufficiently large magnitude, for example, approximately 140 volts DC. The filtered DC voltage is applied via the aforementioned gateway power input connector using a power cord that interfaces with the aforementioned gateway power input connector for energizing a conventional internal AC-to-DC power supply converter of the gateway set-top box. In this way, the same type of gateway set-top box unit can be used by a user who requires the battery backup operation feature and a user who does not require the battery backup operation feature. Advantageously, those users who do not require the battery backup operation feature need not include the separate add-on unit with the gateway set-top box and, consequently, enjoy the associated benefit of cost reduction.

In carrying out another advantageous feature, a detector contained in the gateway set-top box enclosure detects whether the boosted filtered DC voltage is applied to the connector that is indicative of power interruption. When the boosted filtered DC voltage is detected in the detector of the gateway set-top box, it produces an output signal that is used for disabling current consumption in a portion of the circuitry of the gateway set-top box in a manner to reduce the rate of battery discharge. On the other hand, when an unfiltered waveform is detected, either rectified or unrectified, that is indicative of normal uninterrupted power, the entire circuitry of the gateway set-top box is powered.

### SUMMARY

In an advantageous embodiment, an add-on power supply module provides battery backup capability for an electronic apparatus. It includes a backup battery for developing a backup battery voltage and a passive rectifier for rectifying an alternating current (AC), mains supply voltage to develop an unfiltered rectified output supply voltage at an output connector of the power supply module that is adaptable to be selectively connected to an input connector of the electronic apparatus to energize a power supply regulator of the electronic apparatus. The unfiltered rectified output supply voltage charges the backup battery, when the AC mains supply voltage is available. A first sensor detects when the AC mains supply voltage is unavailable. A boost converter is responsive to an output of the first sensor for developing said filtered direct current (DC) boosted supply voltage at the output connector from the backup battery voltage, in substitution for the unfiltered rectified output supply voltage, when the AC mains supply voltage is unavailable.

In another advantageous embodiment, an electronic apparatus includes a power supply regulator and a passive rectifier for rectifying an alternating current (AC), mains supply voltage to energize the power supply regulator, when the AC mains supply voltage is selectively developed at an input connector. The passive rectifier applies an input, unfiltered rectified input supply voltage to energize the power supply regulator, when the unfiltered rectified mains supply voltage is selectively developed at the input connector and applies a filtered direct current (DC) boosted supply voltage that is indicative of battery backup operation to energize the power supply regulator, when the filtered DC boosted supply voltage is selectively developed at the input connector. A sensor responsive to the voltage developed at the input connector senses when the filtered DC boosted supply voltage is selectively developed at the input connector. A switch responsive to an output of the first sensor reduces current loading at the input connector, when sensor is indicative of the filtered DC boosted supply voltage being developed at the input connector, but not when any of the AC mains supply voltage and the unfiltered rectified input supply voltage is sensed by the sensor. The current reduction is implemented by turning off unessential function in the set top box.

### BRIEF DESCRIPTION OF THE DRAWINGS

FIG. 1 illustrates in a partial block diagram a battery backup unit, embodying an advantageous feature; and

FIG. 2 illustrates in a block diagram a gateway set top box, embodying an additional advantageous feature, which is energized by the battery backup unit of FIG. 1.

### DETAILED DESCRIPTION

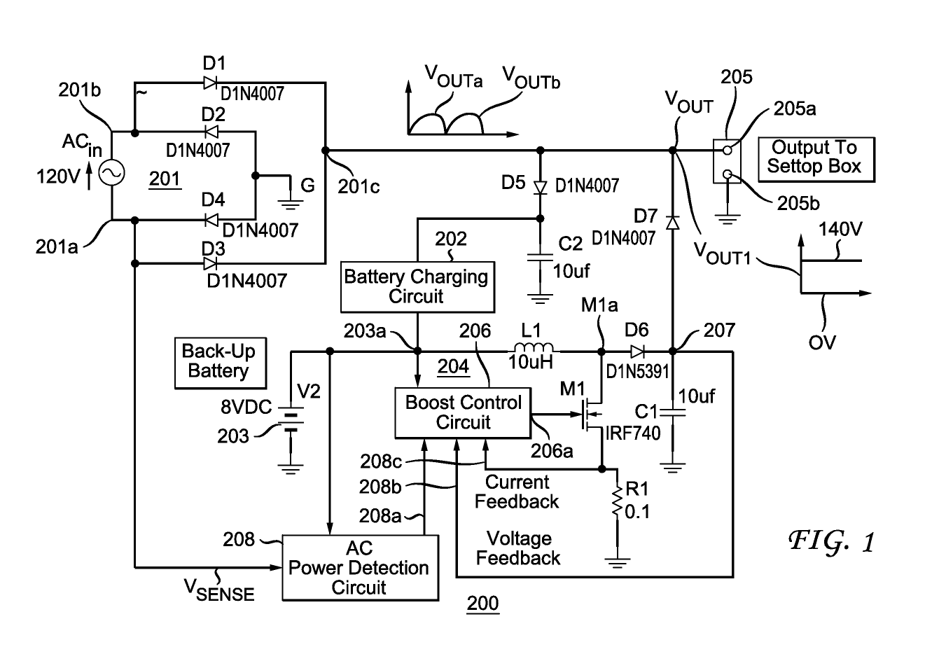

FIG. 1 illustrates, partially in a block diagram, an add-on battery backup unit 200, embodying an advantageous feature. A source, not shown, of an alternating current (AC) mains voltage ACin is coupled to a conventional full-wave bridge rectifier 201. Rectifier 201 includes a diode D4 having an anode coupled to a common conductor G and a cathode coupled to an input terminal 201a. A diode D1 has an anode that is coupled to a second input terminal 201b and a cathode coupled to an output terminal 201c of bridge rectifier 201. Mains voltage ACin is applied between terminals 201a and 201b when terminals 201a and 201b are coupled to, for example, a conventional electric wall plug, not shown. Diodes D4 and D1 rectify a positive half wave, not shown, of voltage ACin to produce a half-wave portion VOUTa of a full wave rectified unfiltered output voltage VOUT, when voltage ACin is uninterrupted. Similarly, full-wave bridge rectifier 201 includes a diode D2 having an anode coupled to common conductor G and a cathode coupled to terminal 201b. A diode D3 has an anode that is coupled to terminal 201a and a cathode coupled to output terminal 201c of bridge rectifier 201. Diodes D2 and D3 rectify a negative half wave, not shown, of voltage ACin to produce a half-wave portion VOUTb of full wave rectified unfiltered output voltage VOUT, when voltage ACin is uninterrupted. Voltage VOUT is applied to an output terminal 205a of a connector 205 of add-on battery backup unit 200. An output terminal 205b of connector 205 is coupled to ground potential G.

In add-on battery backup unit 200, voltage VOUT is, additionally, coupled via a diode D5 and a filter capacitor C2 to a conventional battery charging circuit 202, not shown in details, for energizing battery charging circuit 202 when voltage ACin is uninterrupted. Diode D5 prevents capacitor C2 from filtering voltage VOUT at terminal 205a. Battery charging circuit 202 is coupled to a backup battery 203, for example, of the Lithium-ion (Li-ion) type that produces a battery voltage V2 for energizing a boost converter 204, when an interruption occurs in mains voltage ACin.

Except as noted, boost converter 204 is of a conventional design in that it is energized from lower DC voltage V2 of battery 203 that can be in a voltage range, for example, between 8V and 12V. Boost converter 204 produces, during the power interruption, a filtered constant DC level voltage VOUT1 that excludes significant AC voltage component or ripple. Voltage VOUT1 is developed at terminal 205a at, for example, 140V that is approximately close to the peak voltage of voltage VOUT, prior to an interruption. Thus, voltage VOUT1 is produced in substitution of voltage VOUT that is no longer produced, or could have been produced at a magnitude below a normal operation threshold level, as a result of an interruption referred to as brownout in mains voltage ACin.

A metal oxide field effect transistor (MOSFET) switch M1 is pulse-width modulated by a conventional boost control circuit 206 to store regulated amounts of energy in a boost inductor L1. Inductor L1 is coupled between a terminal 203a of battery 203 and a first main current conducting terminal Mia of MOSFET switch M1. Main current conducting terminal Mia of MOSFET switch M1 is coupled to an anode of a rectifier diode D6 having a cathode that is coupled to a filter capacitor C1 for reducing any significant AC component in voltage VOUT1.

A junction terminal 207, coupled between the cathode of diode D6 and capacitor C1, is coupled to an anode of an isolating/coupling diode D7 having a cathode that is coupled to terminal 205a for developing filtered DC voltage VOUT1, when power interruption occurs. On the other hand, when power interruption does not occur, diode D7 isolates terminal 205a from capacitor C1 to prevent AC voltage from feeding back into boost converter 204 and, in particular, to prevent capacitor C1 from filtering voltage VOUT. Preventing the filtering of voltage VOUT is desirable for implementing an advantageous AC voltage interruption detection, as described later on.

An output signal 206a of boost control circuit 206 is coupled to a gate terminal of MOSFET switch M1 to control its duty cycle. Should voltage VOUT1 tend to decrease, a duty cycle of output signal 206a would tend to increase, resulting in a longer MOSFET switch M1 conduction time. Consequently, output voltage VOUT1 tends to increase. For that purpose, terminal 207 applies in a conventional manner a regulating negative feedback signal to a control input 206b of boost control circuit 206. As a result, the output voltage at terminal 207 is regulated to be constant in the face of varying load current conditions.

MOSFET switch M1 has a second main current conducting terminal that is coupled to a current sensing resistor R1. A junction terminal between resistor R1 and MOSFET switch M1 is coupled to a terminal 206c of boost control circuit 206 to provide in a conventional manner over-current protection for MOSFET switch M1.

Battery voltage V2 is also coupled to energize a conventional AC power detection circuit 208. AC power detection circuit 208 is responsive to a voltage VSENSE developed at terminal 201a for detecting whether AC voltage ACin is within a normal operation range or is interrupted. When AC voltage ACin is present, for example, after being restored, AC power detection circuit 208 produces, in response to voltage VSENSE, a control signal 208a that is coupled to boost control circuit 206 for disabling MOSFET switch M1 via boost control circuit 206. Consequently, generation of voltage VOUT1 is disabled. Instead, generation of voltage VOUT at terminal 205a is restored. On the other hand, when interruption in AC voltage ACin is detected, control signal 208a enables boost control circuit 206 to activate MOSFET switch M1 for producing voltage VOUT1.

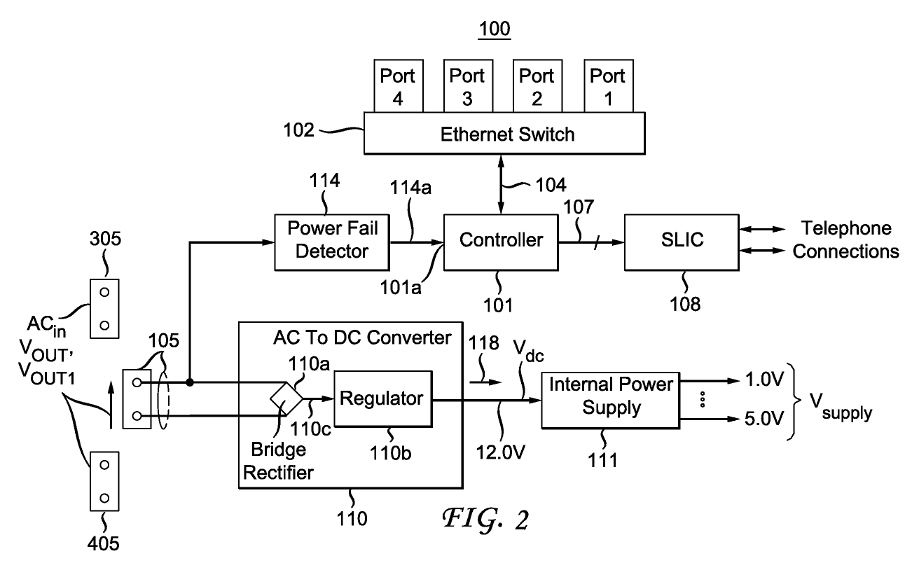

FIG. 2 illustrates a block diagram of a router or gateway set-top box 100, embodying an advantageous feature, for providing internet and phone service at, for example, a user home. Similar symbols and numerals in FIGS. 1 an 2 indicate similar items or functions.

A controller 101 of FIG. 2 is coupled via conductors 104 to a 4-Port Ethernet switch 102 for providing Ethernet connection at the user home. 4-Port Ethernet switch 102 is conventional. Similarly, controller 101 is coupled via conductors 107 to a subscriber line interface card (SLIC) 108 for providing telephone service. SLIC 108 is also conventional.

In a system configuration in which add-on battery backup unit 200 of FIG. 1 is not utilized, a power cord, not shown, applies AC mains voltage ACin having no DC component via a connector 305 of FIG. 2 that mates with an input voltage connector 105 for rectifying voltage ACin in a conventional front end bridge rectifier 110a formed by a four diode, not shown in details, of an AC-to-DC converter 110. On the other hand, in a system configuration in which add-on battery backup unit 200 of FIG. 1 is utilized, a power cord, not shown, electrically connects connector 205 to input voltage connector 105 of FIG. 2 via a connector 405 that mates with connector 105. Thereby, voltage VOUT of FIG. 1 is applied to bridge rectifier 110a in AC-to-DC converter 110, when voltage ACin is available. Similarly, voltage VOUT1 of FIG. 1 is applied to bridge rectifier 110a in AC-to-DC converter 110, when voltage ACin is unavailable.

Bridge rectifier 110a of AC-to-DC converter 110 is constructed similarly to bridge rectifier 201 of FIG. 1. Bridge rectifier 110a of FIG. 2 produces an output voltage 110c that is applied to a conventional voltage regulator 110b. Voltage regulator 110b produces in a conventional manner, not shown in details, a filtered DC voltage Vdc at an output of AC-to-DC converter 110. Voltage Vdc is coupled to a conventional voltage regulator 111 that produces supply voltages collectively referred to as voltages Vsupply for energizing gateway set top box 100 including controllers 101, switch 102 and SLIC 108.

As explained before, when filtered constant DC voltage VOUT1 is generated at connector 205 of FIG. 1 and at connector 105 of FIG. 2, it does not contain a significant AC component. The absence of any significant AC component is indicative of power interruption. On the other hand, when unfiltered full wave rectified voltage VOUT of FIGS. 1 and 2 is generated, a significant AC component is generated so that voltage VOUT developed in connector 105 of FIG. 2 is indicative that no power interruption has occurred.

In carrying out an advantageous feature, a power-fail detector 114 senses the voltage, voltage VOUT or VOUT1, developed in connector 105. A power-fail detecting output signal 114a produced at an output of power-fail detector 114 is indicative whether voltage ACin of FIG. 1 has been interrupted. Output signal 114a of FIG. 2 is coupled to an input terminal 101a of controller 101.

Detector 114 may be implemented, in a conventional manner, not shown, by AC-coupling the voltage developed in connector 105 of FIG. 2 and then rectifying the AC-coupled voltage. When voltage VOUT of FIG. 1 is applied, a significant rectified AC-coupled voltage will be detected for producing power-fail detecting signal 114a of FIG. 2 at, for example, a so-called HIGH level at the output of power-fail detector 114 that is indicative of uninterrupted voltage ACin of FIG. 1.

As explained before, voltage VOUT1 is filtered in capacitor C1 in a manner to exclude significant AC components for enabling power interruption detection in power fail detector 114 of FIG. 2. When voltage VOUT1 is applied, no rectified AC-coupled voltage will be detected in detector 114. Therefore, power-fail detecting signal 114a of FIG. 2 will be generated at a so-called LOW level that is indicative of interrupted voltage ACin of FIG. 1.

It may be desirable to reduce the total current loading from the battery 203 of FIG. 1 in order to lengthen the battery remaining time, during battery backup operation. Thus, in response to signal 114a of power fail detector 114, controller 101 of FIG. 2 initiates, in an otherwise conventional manner, a shutdown procedure or operation of selected functions/devices such as of switch 102. By shutting-down current consumption in switch 102, a reduction of a load current 118 is obtained. Thereby, current consumption from battery 203 of FIG. 1 is, advantageously, reduced. On the other hand, advantageously, controller 101 maintains SLIC 108 operational because it is required to remain active for continuing to provide phone service, during battery backup operation.

1-7. (canceled)

8. An add-on power supply module to provide battery backup capability for an electronic apparatus configured to be energized by an Alternating Current mains supply, the add-on power supply module comprising:
a backup battery for developing a backup battery voltage;
an Alternating Current mains supply input, configured to receive an Alternating Current mains supply voltage;
a power supply output, configured to energize said electronic apparatus;
a rectifier for rectifying an Alternating Current mains supply voltage received on said Alternating Current mains supply input of said add-on power supply module, said rectifier being configured to charge said backup battery and said rectifier being configured to generate an unfiltered rectified Alternating Current voltage at said output of said add-on power supply module;
an Alternating Current power detection circuit configured to detect if said Alternating Current mains supply voltage is available on said Alternating Current mains supply input or if said Alternating Current mains supply voltage is unavailable on said Alternating Current mains supply input; and
a boost converter responsive to an output of said Alternating Current power detection circuit for developing a boosted, filtered Direct Current voltage on said power supply output and to energize said electronic apparatus from said backup battery voltage when said Alternating Current mains supply voltage is unavailable on said Alternating Current mains supply input of said add-on power supply module, in substitution for providing said unfiltered rectified Alternating Current voltage on said output of said add-on power supply module when said Alternating Current mains supply voltage is available on said Alternating Current mains supply input of said add-on power supply module.

9. The add-on power supply module according to claim 8 wherein said rectifier comprises a passive rectifier.

10. The add-on power supply module according to claim 9 wherein said Alternating Current mains supply voltage is applied to an input of said passive rectifier and wherein said passive rectifier isolates said passive rectifier input from said boosted, filtered Direct Current voltage, when said Alternating Current mains supply voltage is unavailable on said Alternating Current mains supply input of said add-on power supply module.

11. A power supply comprised in an electronic apparatus, said power supply comprising:
an Alternating Current mains supply input connector;
a voltage regulator;
a rectifier configured to receive from said input connector of said electronic apparatus, selectively, each one of an unrectified Alternating Current mains supply voltage, an unfiltered rectified Alternating Current voltage and a filtered Direct Current voltage, for generating an output voltage that is applied to said voltage regulator to generate a regulated supply voltage for energizing said electronic apparatus;
a sensor for sensing when said filtered Direct Current voltage is received at said Alternating Current mains supply input; and
a switch responsive to an output of said sensor and coupled to said electronic apparatus for reducing current loading at a load in said electronic apparatus and at said Alternating Current mains supply input, when said filtered Direct Current voltage is received at said power input and for avoiding the current loading reduction when either one of said Alternating Current mains supply voltage and said unfiltered rectified Alternating Current voltage is received at said Alternating Current mains supply input.

12. A power supply according to claim 11 wherein each of said unfiltered rectified Alternating Current voltage and said filtered Direct Current voltage is provided by an add-on power supply module that is a separate unit from a unit containing said electronic apparatus.
